(19) United States
(12) Patent Application Publication
(10) Pub. No.: US 2025/0332573 A1
(43) Pub. Date: Oct. 30, 2025

(54) High Surface Area Catalyst

(71) Applicant: Swansea University, Swansea (GB)

(72) Inventor: Richard Palmer, Swansea (GB)

(21) Appl. No.: 18/996,864

(22) PCT Filed: Aug. 1, 2023
(86) PCT No.: PCT/GB2023/052040

§ 371 Date: Jan. 17, 2025

(30) Foreign Application Priority Data
Aug. 2, 2022 (GB) 2211271.8

(51) Int. Cl. B01J 21/18; B01J 23/745; B01J 35/60; B01J 37/34; C01C 1/04

(52) U.S. Cl. CPC B01J 21/18; B01J 23/745; B01J 35/60; B01J 37/347; C01C 1/0411

(57) ABSTRACT

The invention concerns a nanocomposite material for use as a high surface area heterogenous or electrocatalyst, and methods for preparing such catalysts.

### FIELD OF THE INVENTION

The invention concerns a nanocomposite material for use as a high surface area heterogenous or electrocatalyst, and methods for preparing such catalysts. The invention also extends to a process for manufacture of ammonia under mild conditions comprising the use of said nanocomposite as a heterogenous catalyst.

### BACKGROUND OF THE INVENTION

Heterogeneous catalysts consist of small particles, typically metals, which are dispersed over a high surface area, solid support. The high surface area is necessary for a good rate of catalytic transformations.

The physical deposition of atoms or clusters of atoms (small nanoparticles) from a beam is an alternative to the well-established chemical methods normally used to produce supported catalyst particles. The recent scaling up of the intensity of cluster beams strengthens this new route to the fabrication of functional nanostructured materials. However, a challenge is to present to the directed beam the necessary high surface areas of the desired support material.

The directional and ballistic nature of the cluster beam generated by a cluster source, or of a beam of atoms from an atom source such as an evaporator, presents challenges for coating a high surface area support in an even way, thus to allow high turnover catalytic function. Scaled-up cluster beam sources are now available, which are capable of depositing fractions of a gram of clusters per hour onto a support to create functional materials such as catalysts [1,2]. But to take full advantage of these new instruments, such as the Matrix Assembly Cluster Source [3, 4], we must learn to present, to the directed beam, large surface areas of the support material to enable decoration by the clusters (or atoms) at local sub-monolayer densities. If a planar support were used, the clusters would just pile up into large particles.

An alternative technology is to agitate or stir a powder in a cup while it is coated (from above) by the cluster beam. Several examples of heterogeneous catalysis with such cluster-beam-decorated powder materials have been reported [5-7]. A problem of cluster deposition onto powders, however, is that the impact parameters of the cluster-surface collision vary, because each powder particle presents a curved surface at uncontrolled angle to the incoming cluster at the moment of landing. If the fate of the cluster-in terms of its final shape on, and diffusion across, the surface-depends on the precise landing site and angle, non-uniform cluster coverage and morphology may well result. Presenting to the cluster beam a planar surface at normal incidence overcomes this problem, but obviously limits the surface area that can be decorated, if we suppose the preservation of individual clusters is required to optimize the functional behaviour.

Here we demonstrate, when depositing clusters onto a porous support material from a Matrix Assembly Cluster Source (MACS), one can achieve well dispersed clusters impregnated into the material to achieve large surface area deposition. This provides for a nanoparticle-decorated porous support, which can be used as a catalyst for heterogenous catalytic or electrocatalytic processes.

Without wishing to bound by theory, by using a porous support material whose microscopic surface area, available for cluster binding, is enormously higher than the macroscopic projected surface area of the material, we can achieve increased discrete particle deposition on the catalyst support material; the open pores present numerous binding sites to stop and trap the incoming clusters or atoms. Further, controlled loading and dispersion can be advantageously achieved using this process. This unique demonstration of cluster and atom beam deposition into porous materials has obvious practical relevance in a wide number of applications, such as heterogeneous and electro-catalyst fabrication, as well as fundamental interest for science and engineering.

### STATEMENTS OF INVENTION

The present invention, in its various aspects, is as set out in the accompanying claims.

According to a first aspect of the invention there is provided a nanocomposite material comprising a porous support substrate, said material comprising a plurality of atomic clusters supported on the surface of and impregnated in the pores of the porous support substrate, wherein said substrate has a mean pore size to substrate thickness ratio of at least 0.05:1, and wherein each of said atomic clusters comprises from 1 to 20,000 atoms.

According to a second aspect of the invention there is provided a nanocomposite material comprising a porous support substrate a nanocomposite material comprising a porous support substrate, said material comprising a plurality of atomic clusters supported on the surface of and impregnated in the pores of the porous support substrate, wherein said substrate has mean pore size of at least 1 μm, and wherein each of said atomic clusters comprises from 1 to 20,000 atoms.

In some preferred embodiments, each of said atomic clusters comprises from 1 to 5,000 atoms, and more preferably from 1 to 1000 atoms. In particularly preferred embodiments, each of said atomic clusters comprises from 1 to 10 atoms. In alternative, equally preferred embodiments, each of said atomic clusters comprises from 100 to 200 atoms.

The use of a porous support substrate as defined above allows for the direct implantation of atomic clusters into the substrate whose microscopic area is enormously higher than the macroscopic projected surface area of the substrate. In particular, it has been surprisingly shown that atomic clusters can be implanted and trapped deep within the pores of such substrates to a depth comparable to the mean pore diameter. Thus, large surface area deposition and trapping of said clusters within the support substrate has been achieved for the first time.

As would be readily apparent to a person of ordinary skill in the art, the mean pore size of a substrate can be measured or calculated by a variety of methods. For example, mean pore size is typically measured by the Brunauer-Emmett-Teller (BET) method or by electron microscopy.

Preferably, the substrate has a mean pore size to substrate thickness ratio of at least 0.1:1, more preferably at least 0.15:1, still more preferably at least 0.2:1, and most preferably at least 0.25:1. Additionally or alternatively, the substrate preferably has a mean pore size to thickness ratio of no more than 0.5:1, more preferably no more than 0.4:1 and still more preferably no more than 0.3:1.

As would be readily apparent to a person of ordinary skill in the art, as used herein the term ‘substrate’ refers to a layer of material into and onto which atomic clusters are to be deposited. Such a substrate layer may be a single layered uniform material or may be one layer of a more complex, multi-layered structure. In preferred embodiments, the substrate has a mean pore size of at least 5 μm, more preferably at least 10 μm and still more preferably at least 25 μm. Additionally or alternatively, the substrate preferably has a mean pore size of no more than 500 μm, more preferably no more than 250 μm and still more preferably no more than 100 μm. For example, substrates having a mean pore size of 50 μm have been used to prepare the high surface area, atomic cluster decorated, nanocomposite materials for use as catalyst materials.

In preferred embodiments, the substrate has a thickness of at least 50 μm, more preferably at least 100 μm and still more preferably at least 200 μm. Additionally or alternatively, the substrate has a thickness of no more than 400 μm, more preferably no more than 300 μm, and still more preferably no more than 250 μm. As noted above, the thickness of the substrate relates specifically to the layer of material into and onto which atomic clusters are to be deposited. Therefore, such substrates may be a single layered uniform material or, alternatively, may form one component or layer of a complex, non-uniform and/or multi-layered structure having a total thickness greater than that recited of the substrate per se.

Substrates having a thickness of 200 μm and a mean pore size of 50 μm, i.e. having a mean pore size to substrate thickness ratio of 0.25:1, have been shown to be particularly suitable.

In preferred embodiments, the nanocomposite material comprises from about 0.02 mg to about 200 mg of said atomic clusters per cm² (macroscopic surface-projected area) of said porous support substrate. More preferably, the nanocomposite materials may comprise up to about 20 mg, still more preferably up to about 2 mg and most preferably up to about 0.2 mg of said deposited atomic clusters per cm² (macroscopic surface-projected area) of said porous support substrate.

The porous support substrate on/in which the atomic clusters are deposited and supported is not particularly limited. Suitable substrates include, but are not limited to, porous carbon (e.g. carbon paper), porous silicon, porous metal (e.g. porous titanium) and polymermic membranes. However, in preferred embodiments, the substrate is a porous carbon material such as carbon paper, and/or may optionally be doped with one or more heteroatom (i.e. nitrogen, suphur or oxygen) containing dopant materials.

Preferably, where a doped porous carbon support substrate is used, said dopant(s) comprise one or more nitrogen heteroatom. More preferably, the substrate comprises a carbon material doped with pyridinic and/or pyrrolic nitrogen atoms. The inclusion of such dopants prevents the diffusion of the atomic clusters on/in/through the substrate.

Preferably, where a doped carbon material is used as the substrate, the dopant preferably covers from 0.1 to 20%, more preferably from 1 to 10%, and still more preferably from 2 to 5%, of the macroscopic surface-projected area of the substrate. Dopant surface coverage is typically measured via projected surface area derived from deposition beam flux and XPS.

In preferred embodiments, the atomic clusters comprise, or consist, of one or more metal atoms. More preferably, the atomic clusters comprise, or consist, of one or more metals selected from: lead (Pb), silver (Ag), gold (Au), platinum (Pt), molybdenum (Mo), tungsten (W), rhenium (Re), cobalt (Co), ruthenium (Ru), rhodium (Rh) and iron (Fe). Still more preferably, the atomic clusters comprise, or consist, of one or more metals selected from: Pt, Mo, Re, Co, Ru, Rh and Fe, and still more preferably from: Mo, Re, Fe and Pt atoms. In particularly preferred examples, the atomic clusters comprise, or consist of Fe atoms. Said atom clusters may comprise individual atoms or may comprise a mixture or alloy comprising multiple atoms. The metal atoms may be covalently or non-covalently modified and/or may be in an oxidised or reduced form. Such metal atomic clusters are particularly suitable for use as atomic metal catalysts for heterogenous catalytic or electrocatalytic processes.

Therefore, according to a third aspect of the invention, there is provided a heterogenous or electrocatalyst comprising the nanocomposite material of the first or the second aspect.

Further, according to a fourth aspect, the invention extends to the use of the nanocomposite material of the first or the second aspect as a heterogenous or electrocatalyst.

As would be readily apparent to a person of ordinary skill in the art, the nanocomposite material of the first aspect and or second aspect of the invention may be formed via any conventional physical vapour deposition (PVD) process such as by evaporation, sputtering or pulsed laser deposition. Such PVD processes may comprise a cluster deposition process, wherein metal atom clusters are formed (e.g., via condensation in the gas phase) and then deposited onto and within the porous substrate. Alternatively, said PVD techniques may comprise an atom deposition process, wherein individual metal atoms are deposited, and then form metal atom clusters, onto and within the substrate.

Therefore, according to a fifth aspect of the invention, there is provided a method for preparing the nanocomposite of the first or the second aspect, said method comprising depositing a plurality of atomic clusters onto the surface of a solid substrate by PVD, wherein each atomic cluster independently comprises from 1 to 20,000 atoms. Suitable PVD methods include, but are not limited to, cluster beam deposition, laser ablation deposition, thermal evaporation deposition and magnetron sputtering deposition.

In preferred embodiments, the nanocomposite material is formed by the deposition/impregnation of said atomic clusters on/in said porous support substrate by a cluster beam deposition method. In such embodiments, the method comprises the following steps:
(i) disposing within a matrix assembly cluster source (MACS) deposition chamber, a porous support substrate and a cluster target material comprising or consisting of atoms to be deposited as atomic clusters on/in said substrate;
(ii) forming a solid matrix comprising one or more source of Group 18 (noble gas) atoms in combination with atoms to be deposited as atomic clusters; and
(iii) performing a sputtering step in said deposition chamber, wherein said step comprises ion bombardment of the matrix formed in step (ii) to form a beam of atomic clusters which are directly deposited on to the surface and into the pores of said porous support substrate.

Preferred features relating to the porous support substrate are as described in connection with the first and/or second aspects.

Preferably, the cluster target material comprises or consists of atoms of one or more metals, more preferably atoms selected from lead (Pb), silver (Ag), gold (Au), platinum (Pt), molybdenum (Mo), tungsten (W), rhenium (Re), cobalt (Co), ruthenium (Ru), rhodium (Rh) and/or iron (Fe), to be deposited as atomic clusters. The cluster target material may be a single element or may be a mixture or alloy comprising multiple elements. The cluster target material may comprise covalently or non-covalently modified metal atoms and/or may be in an oxidised or reduced form.

Preferably, step (ii) comprises forming a solid matrix comprising atoms of one or more Group 18 element, more preferably argon atoms, and atoms or one or more metals, more preferably atoms selected from lead (Pb), silver (Ag), gold (Au), platinum (Pt), molybdenum (Mo), tungsten (W), rhenium (Re), cobalt (Co), ruthenium (Ru), rhodium (Rh) and iron (Fe).

In preferred embodiments, step (iii) comprises bombardment with an Ar⁺ ion beam, wherein said ion beam has a deposition energy of from about 0.1 to 10 kV, more preferably from about 0.25 to 5 kV and most preferably from about 0.5 to 1.5 kV.

In preferred evaporation deposition methods, the method comprises the following steps:
(i) disposing within a thermal evaporator, a porous support substrate and a cluster target material comprising or consisting of atoms to be deposited as atomic clusters on said substrate;
(ii) lowering the pressure within said evaporator to generate a vacuum; and
(iii) heating the cluster target material under vacuum, thereby generating evaporated cluster target particles, which are subsequently deposited on to the surface and into the pores of said porous support substrate by condensation.

As used herein, the term ‘vacuum’ relates to a closed environment having gas pressure of about 10⁻⁴ Pa or below.

Again, the cluster target material preferably comprises or consists of atoms of one or more metals, more preferably atoms selected from lead (Pb), silver (Ag), gold (Au), platinum (Pt), molybdenum (Mo), tungsten (W), rhenium (Re), cobalt (Co), ruthenium (Ru), rhodium (Rh) and iron (Fe), to be deposited as atomic clusters. Still more preferably, the cluster target material comprises or consists of atoms selected from: Pt, Mo, Re, Co, Ru, Rh and Fe, and still more preferably from: Mo, Re, Fe and Pt atoms. In particularly preferred examples, the cluster target material comprises or consists of Fe atoms. Preferred features relating to the porous support substrate are as described in connection with the first and/or second aspects.

As noted above, it has been surprisingly shown that atomic clusters can be implanted and trapped deep within the pores of porous substrates to a depth comparable to the mean pore diameter. Therefore, according to a sixth aspect of the invention, there is provided a method for controlling the depth of deposition of atomic clusters within a porous support substrate, wherein the method comprises the following steps:
(i) providing a porous support substrate in which the mean pore size of said substrate is between 0.8 d and 1.2 d, and preferably between 0.9 d and 1.1 d, wherein d represents the maximum depth to which said atomic clusters are intended to be deposited; and
(ii) depositing a plurality of atomic clusters onto the surface and into the pores of said porous support substrate by PVD, wherein each of said atomic clusters comprises from 1 to 20,000 atoms.

Preferred features relating to the porous support substrate, atomic clusters and PVD methods are as described in connection with the previous aspects.

Also as noted above, the nanocomposite materials of the first and/or second aspects of the invention, in particular nanocomposite materials comprising metal atomic clusters, may be used to catalyse a variety of different chemical reactions, including heterogeneous reactions.

Typically, iron is used in industry as a catalyst for ammonia synthesis, although it is well understood that a wide variety of alternative transition metals, in particular Pt, Mo, Re, Co, Ru and/or Rh, are equally suitable. Consistent with this, we have found that the nanocomposite materials of the first and/or second aspects of the invention are capable of catalysing the synthesis of ammonia (NH₃) via the reduction of N₂ under low temperature and low pressure in comparison to current industrial processes (e.g. the Haber-Bosch process) for producing NH₃.

Therefore, according to a Seventh aspect, there is provided a process for the production of ammonia, the process comprising:
(i) disposing in a reactor a catalyst bed comprising a nanocomposite material according to the first or second aspect of the invention;
(ii) passing one or more sources of nitrogen (N₂) and one or more sources of hydrogen (H₂) over said catalyst bed;
(iii) obtaining a product stream comprising ammonia (NH₃).

In particularly preferred embodiments, said nanocomposite material comprises a plurality of, iron atomic clusters.

Preferably, step (ii) is carried out at a temperature at or below 250° C., more preferably at or below 200° C. and still more preferably at or below 150° C.

Alternatively or additionally, step (ii) is preferably carried out at a temperature at or above 20° C., and more preferably at or above 30° C.

In exemplary embodiments, step (ii) may be carried out at a temperature in the range of from about 20° C. to about 250° C., such as from about 30° C. to about 75° C., or from about 30° to less than about 50° C. Further, in preferred embodiments, step (ii) is carried out at a pressure of no more than about 3 MPa (30 bar), more preferably no more than about 2 MPa (20 bar), still more preferably no more than about 1 MPa (10 bar), and even more preferably no more than about 0.5 MPa (5 bar). For example, step (ii) may be caried out under standard atmospheric pressure conditions, i.e. about 0.1 MPa (1 bar).

Step (ii) can also be carried out at below atmospheric pressure. For example, catalytic N2 reduction has been exemplified at pressures from about 250 to about 750 Pa (2.5 to 7.5 mbar), and more preferably about 500 Pa (5 mbar).

In preferred embodiments, the catalyst bed is reduced prior to step (ii). Catalyst reduction can be achieved by, e.g. exposure to H2 at elevated temperature (e.g. up to about 400° C.).

Preferably, the one or more source of hydrogen is prepared from a green hydrogen feedstock. For example, hydrogen can be prepared from water by electrolysis.

Preferably, the process is powered by renewable energy, non-limiting examples of which include solar and wind power. By combining the use of renewable energy and a green hydrogen feedstock, ammonia can be prepared via a zero-carbon process.

Preferred features of each aspect of the invention may be as described in connection with any of the other aspects.

Throughout the description and claims of this specification, the words “comprise” and “contain” and variations of the words, for example “comprising” and “comprises”, mean “including but not limited to” and do not exclude other moieties, additives, components, integers or steps. Throughout the description and claims of this specification, the term “and/or” includes any and all combinations of one or more of the associated listed elements. Throughout the description and claims of this specification, the singular encompasses the plural unless the context otherwise requires. In particular, where the indefinite article is used, the specification is to be understood as contemplating plurality as well as singularity, unless the context requires otherwise. Throughout the description and claims of this specification, the word “about” means ±5%, alternatively ±2% unless the context otherwise requires.

Throughout the description and claims of this specification, the term “metal atom cluster(s)” and variations thereof includes single metal atom(s) and aggregations of a plurality of metal atoms unless the context otherwise requires.

All references, including any patent or patent application, cited in this specification are hereby incorporated by reference. No admission is made that any reference constitutes prior art. Further, no admission is made that any of the prior art constitutes part of the common general knowledge in the art.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

The Invention will now be described by way of example only with reference to the Examples below and to the following Figures wherein:

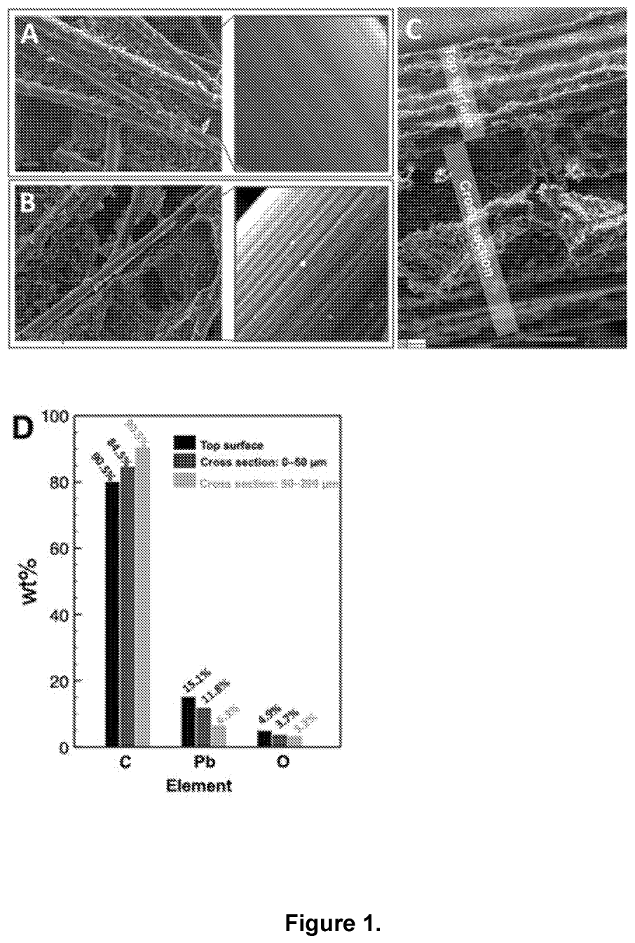

FIG. 1. [A] SEM images of bare carbon paper and [B] of lead deposited into the carbon paper. [C] EDX mapping of a cross-section of Pb-C paper, showing the Pb clusters are mainly located in the upper section of the carbon paper with a depth of 50 μm. [D] Average element concentration in weight % of C, Pb and O from the 3 different sections of the Pb-C paper: top surface, cross section over 0-50 μm depth and cross section over 50-200 μm depth;

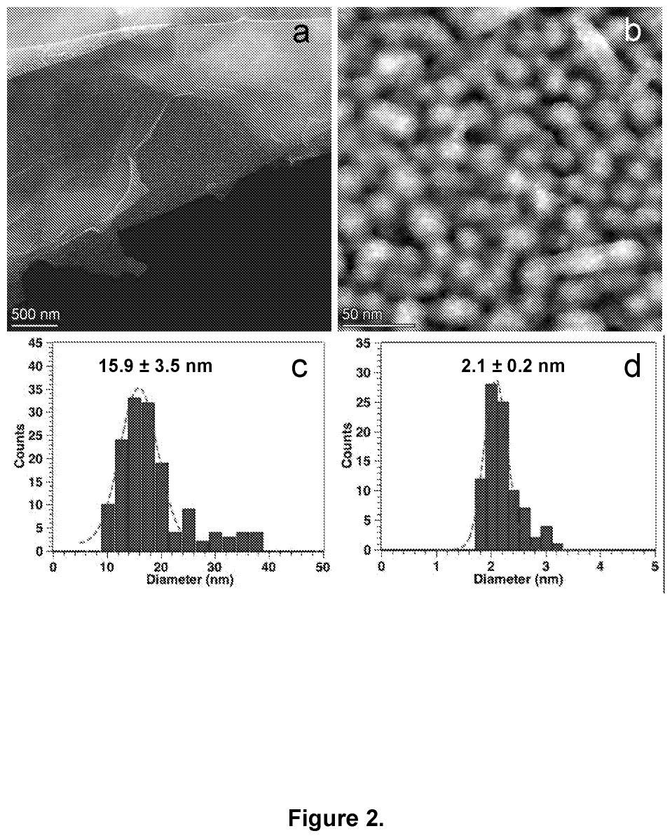

FIG. 2. HAADF-STEM images of carbon paper after Pb cluster deposition under low magnification [A] and high magnification [B]. The carbon paper presents sphere-like structures with a mean diameter of 15.9 nm [C], and those spheres are decorated with Pb clusters with a mean diameter of 2.1 nm;

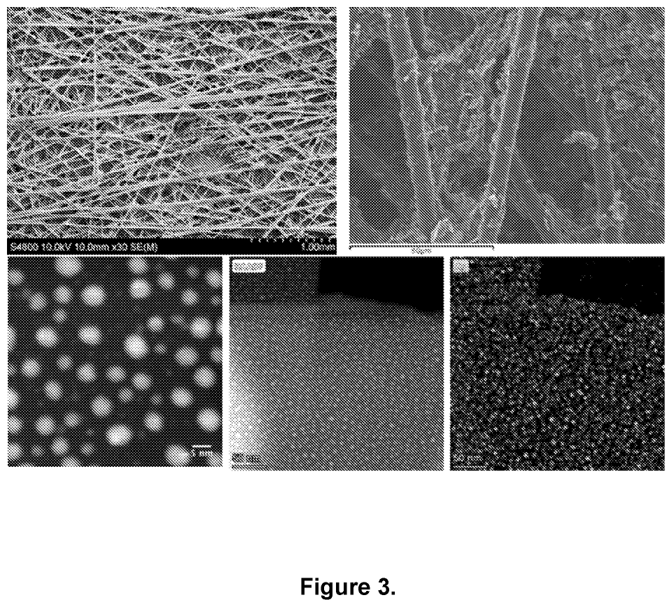

FIG. 3. SEM, STEM and STEM-EDS mapping of Ag-C paper. [A-B] show the porous nature of carbon paper which consists of carbon fibres and flakes. [C-E] show the Ag clusters deposited into carbon paper; and

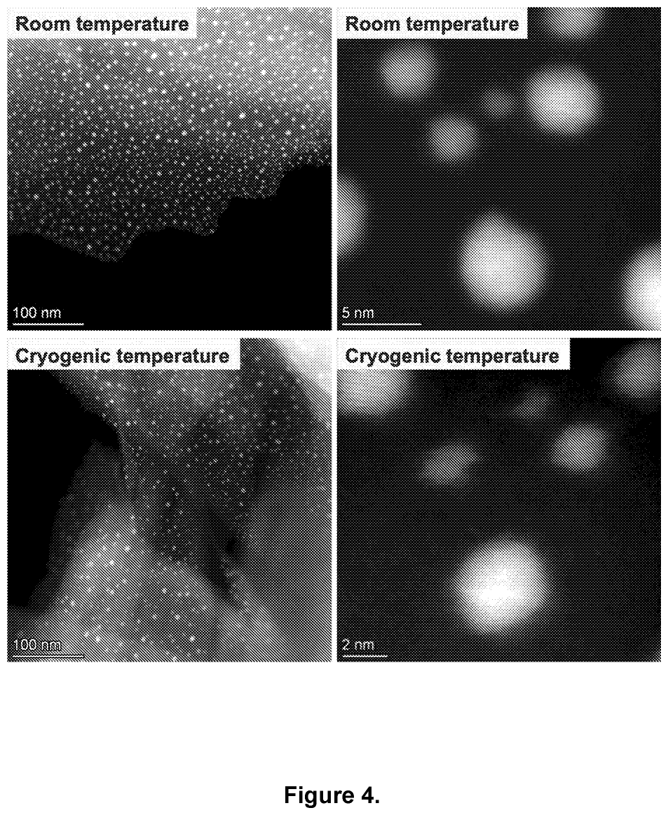

FIG. 4. STEM images of Au-C paper prepared by Au evaporation with the carbon held at room temperature or cryogenic temperature (separate samples). The density of the Au atoms is so high that they aggregate into clusters typically <10 nm in diameter. Some atoms are just about visible in the bottom right image.

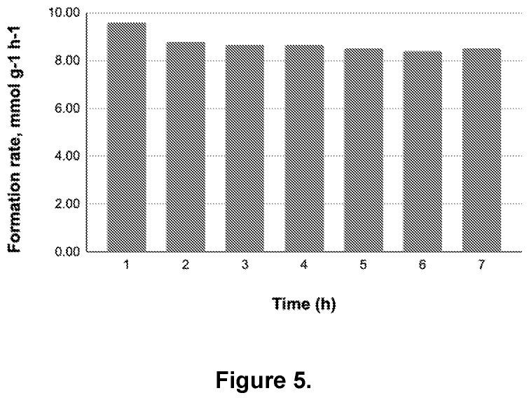

FIG. 5. The catalytic activity of Fe-CP (carbon paper) towards ammonia production (200° C.; 10 bar). The metal loading of Fe clusters on carbon paper is normalised to 0.1%. The products were analysed with gas chromatography each hour.

### MATERIALS AND METHODS

The implantation of metal clusters (lead and silver demonstrated here) into porous carbon paper was accomplished with the Matrix Assembly Cluster Source (MACS) technique [1]. The carbon paper (Sigracet 29 AA, SGL Carbon) used in this work has a thickness of about 200 μm, with a mean pore size of about 50 μm diameter. The carbon paper (circular shape) with diameter 10 cm was introduced into the deposition chamber from a load-lock chamber prior to metal cluster deposition from the MACS.

The details of the MACS cluster beam technique have been described previously [1]. The metal clusters were formed and deposited onto (into) carbon paper in the MACS3 [6] deposition chamber. An oxygen-free copper support was cooled to around 20 K by a closed-loop helium cryocooler, then a solid cryo-matrix of metal atoms and argon (Ar) atoms was produced on the surface of the copper support, by evaporating Pb or Ag atoms and dosing Ar gas at the same time. After the formation of the matrix, an Ar⁺ ion beam (1.1 KV, 15-20 mA) was employed to sputter the matrix, creating a beam of metal clusters, which were directly deposited onto the carbon paper. The clusters are formed by collision cascades in the matrix.

During the formation of the matrix, a quartz crystal microbalance was used to measure the metal evaporation rate into the matrix, 10 Å/s. The Ar dosing pressure was set (4.5×10⁻⁴ mbar) to achieve a metal loading in the matrix of ˜4% by number of atoms. In the case of Pb, the production and deposition of the Pb clusters was achieved by sputtering the matrix for 1 hour. The carbon paper was rotated on a stage throughout the entirety of the deposition to achieve uniform deposition. We estimate that the total mass of Pb clusters deposited onto (into) the carbon paper was about 1.45 mg for the scanning transmission electron microscopy (STEM) study and 4.40 mg for the SEM and electrochemical studies, i.e., 0.018 mg/cm² and 0.056 mg/cm², respectively. The implantation of Ag clusters was done by a metal loading of ˜4% and sputtering time of 11 mins.

Single atoms are the lowest limit in size of a cluster. Gold atoms were deposited onto (into) porous carbon paper by evaporation from a standard thermal evaporator in vacuum. A piece of carbon paper was directly mounted onto the block. A beam of gold was generated by a thermal evaporator. In order to limit the aggregation of the gold atoms in the carbon, the deposition time was limited to 65 s. This process was done in high vacuum without introducing Ar gas.

In a further example, iron clusters (approx. maximum cluster size 1 nm) were implanted into porous carbon paper using a magnetron sputtering technique, covering both sides of the carbon paper substrate with a thin layer (0.3-0.5 nm) of iron clusters. Then, the catalytic activity of the iron cluster coated carbon paper towards ammonia production was measured using a high pressure reactor and the products were analysed using gas chromatography or liquid chromatography. Specifically, the reaction was tested at a temperature of 200° C. and a pressure of 1 MPa (10 bar) in a mixture of N₂ (10 ml/min) and H₂ (30 ml/min) following dilution of the catalyst with SiC powder to improve the heat transfer.

### RESULTS

The microscopic morphology of the C-paper before and after implantation with lead clusters was characterised with SEM. Chemical information on the Pb-C samples was revealed with EDX analysis. SEM images of the bare carbon paper support and Pb-C paper are shown in FIGS. 1a and 1b, respectively.

The carbon substrate was characterised by interconnected carbon fibres with an average thickness of 7 μm as well as carbon particles and flakes with a diameter ranging from 10 to 30 μm, randomly scattered over the material. Changes in the surface morphology of the carbon fibres as a result of Pb coating confirm that lead was successfully deposited. Additionally, from magnified sections of the SEM images, the surface of the pristine C-paper appeared smooth whereas the surface of the Pb-C paper after presentation to the cluster beam became rougher.

For cross-sectional analysis, the samples were cut with a surgical blade and mounted vertically on the SEM sample holder. The cross-sectional SEM and

EDX analysis of the Pb-C paper, FIG. 1c, confirmed that the ˜200 μm thick carbon film was built of interconnected carbon fibres and particles as described, with pores evident throughout the material, providing open channels for the directed lead clusters to penetrate into. The upper cross section (0-50 μm depth) shown in FIG. 1c showed abundant lead cluster implantation to a depth of up to ˜50 μm from the top surface of the C-paper, which is comparable with the pore size. The lower cross section (50-200 μm depth) showing a reduced amount of lead within the C-paper; this section had a depth ˜150 μm. EDX analysis of the Pb-C paper shown in FIG. 1d indicates that the concentration of Pb decreases from top surface to cross section. ˜ 45.5 % of the total amount of Pb was found on the top surface of the carbon paper, and the other ˜54.5% infiltrated the paper and settled on the inner carbon fibres.

A small section with a diameter of ˜3 mm was cut from the Pb-carbon paper for scanning transmission electron microscopy (STEM) imaging. The STEM imaging was performed using a Thermo Scientific Talos F200X Transmission Electron Microscope operating at 200 KV in the high-angle annular dark-field (HAADF) mode. The images were taken from an ultrathin area located on a (carbon) flake of the carbon paper. It can be seen from FIG. 2a that the surface of the Pb-carbon paper is covered with sphere-like structures. FIG. 2b shows that those sphere-like structures are decorated with small Pb clusters. The HAADF contrast indicates that the spheres themselves are carbonaceous rather than Pb, as the small Pb clusters would not be visible if the spheres were Pb.

In order to study the size of the structures assigned to carbon spheres and Pb clusters, their projected surface areas were measured and converted into equivalent diameters. 148 carbon spheres and 260 Pb nanoparticles were measured for the size distributions of FIGS. 2c and 2d. The carbon structures have a mean diameter of 15.9 nm, while the Pb clusters have a mean diameter of 2.1 nm.

FIG. 3 shows SEM, STEM and EDS mapping of a Ag-C system, i.e., produced by Ag cluster deposition from the MACS into porous carbon paper (same as for Pb). The porous and fibrous nature of the carbon paper is again evident from the SEM images (FIG. 3a and b). The approximately spherical shape of the Ag clusters landed on the carbon is confirmed by the STEM-HAADF images (FIGS. 3c and 3d). The nanoparticles have a size ranging from 1 to 6 nm in diameter. EDS mapping (FIG. 3e) confirms the nanoparticles are Ag.

FIG. 4 shows HAADF-STEM images of a sample after Au atoms have been evaporated into it, creating Au atoms/clusters. The effect of temperature was studied by preparing the sample under room temperature and cryogenic temperature. Although the deposition time for both samples is just 65 s, the density of the Au atoms is so high on the surface that they form clusters. The images were taken within the pore area of a thin carbon flake. The intensity of single atoms is much lower than that of clusters, the single atoms are barely visible in the high magnification image. As most of the atoms aggregated into clusters due to the high density, the role that the temperature plays in this case is not clear.

FIG. 5 shows the catalytic activity of the Fe-carbon paper system towards ammonia production. Notably, the catalyst was seen to stabilise during the first two hours of the reaction (as shown in the drop of catalytic activity) before stabilising for the remaining duration of measurement (7 hours)

### SUMMARY

In this demonstration, we presented, to cluster and atom beams, a porous support material. We showed the production of metal clusters inside the porous support, to a certain depth comparable with the pore size. The microscopic surface area of porous support, available for cluster binding, is enormously higher than the macroscopic projected surface area of the material.

Pb clusters with an average diameter of ˜2 nm were fabricated with the MACS technique and deposited into porous C-paper. Both STEM and SEM studies together with EDX mapping confirm the successful implantation of Pb clusters to form the nanocomposite Pb cluster-C paper hybrid material system. The EDX analysis indicates that the Pb clusters are implanted to a depth into the carbon paper comparable with the pore size of the carbon paper, in this case about 50 microns.

An Ag cluster-C paper hybrid material was also successfully fabricated and imaged as a further example of this new technique.

The deposition of Au atoms by evaporation in vacuum into porous carbon paper was also demonstrated. Clusters and atoms have been observed inside the pores.

The deposition of Fe clusters (approx. maximum cluster size 1 nm) by magnetron sputtering into porous carbon paper was also demonstrated and shown to catalytically active towards ammonia production under milder conditions than those conventionally used in the Haber-Bosch process.

These hybrid nano-systems hold promise for heterogeneous catalysis, electrocatalysis and many other applications.

### REFERENCES

[1] Palmer, R. E.; Cao, L.; Yin, F., Note: Proof of principle of a new type of cluster beam source with potential for scale-up. Rev. Sci. Instrum. 2016, 87, 3.
[2] Sanzone, G.; Yin, J. L.; Sun, H. L., Scaling up of cluster beam deposition technology for catalysis application. Front. Chem. Sci. Eng. 2021, 15, 1360-1379.
[3] Spadaro, M. C.; Cao, L.; Terry, W.; Balog, R.; Yin, F.; Palmer, R. E., Size control of au nanoparticles from the scalable and solvent-free matrix assembly cluster source. J. Nanopart. Res. 2020, 22, 6.
[4] Ellis, P. R.; Brown, C. M.; Bishop, P. T.; Yin, J. L.; Cooke, K.; Terry, W. D.; Liu, J.; Yin, F.; Palmer, R. E., The cluster beam route to model catalysts and beyond. Faraday Discuss. 2016, 188, 39-56.
[5] Xu, J. Y.; Murphy, S.; Xiong, D. H.; Cai, R. S.; Wei, X. K.; Heggen, M.; Barborini, E.; Vinati, S.; Dunin-Borkowski, R. E.; Palmer, R. E., et al., Cluster beam deposition of ultrafine cobalt and ruthenium clusters for efficient and stable oxygen evolution reaction. ACS Appl. Energ. Mater. 2018, 1, 3013-3018.
[6] Cai, R. S.; Martelli, F.; Vernieres, J.; Albonetti, S.; Dimitratos, N.; Tizaoui, C.; Palmer, R. E., Scale-up of cluster beam deposition to the gram scale with the matrix assembly cluster source for heterogeneous catalysis (catalytic ozonation of nitrophenol in aqueous solution). ACS Appl. Mater. Interfaces 2020, 12, 24877-24882.
[7] Cai, R. S.; Cao, L.; Griffin, R.; Chansai, S.; Hardacre, C.; Palmer, R. E., Scale-up of cluster beam deposition to the gram scale with the matrix assembly cluster source for heterogeneous catalysis (propylene combustion). AIP Adv. 2020, 10, 5.

1. A nanocomposite material comprising a porous support substrate, said material comprising a plurality of atomic clusters supported on the surface of and impregnated in the pores of the porous support substrate, wherein said substrate has a mean pore size to substrate thickness ratio of at least 0.05:1, and wherein each of said atomic clusters comprises from 1 to 20,000 atoms.

2. A nanocomposite material comprising a porous support substrate, said material comprising a plurality of atomic clusters supported on the surface of and impregnated in the pores of the porous support substrate, wherein said substrate has mean pore size of at least 1 μm, and wherein each of said atomic clusters comprises from 1 to 20,000 atoms.

3. The nanocomposite material according to claim 1, wherein said substrate substate has a thickness of at least 50 μm.

4. The nanocomposite material according to claim 1, wherein the nanocomposite material comprises from about 0.02 mg to 200 mg of said atomic clusters per cm2 of the macroscopic surface-projected area of said porous support substrate.

5. The nanocomposite material according to claim 1, wherein the substrate is selected from a porous carbon, porous silicon, porous metal and a polymermic membrane.

6. The nanocomposite material according to claim 5, wherein said substrate is a porous carbon material.

7. The nanocomposite material according to claim 6, wherein said carbon material is doped with one or more heteroatom containing dopants, optionally wherein said dopant(s) cover from 0.1 to 20% of the macroscopic surface-projected area of the substrate.

8. The nanocomposite material according to claim 1, wherein each of the atomic clusters comprises one or more metal atoms.

9. The nanocomposite material according to claim 8, wherein each of the atomic clusters comprises one or more metals selected from: lead, silver, gold, platinum, molybdenum, tungsten, rhenium, cobalt, ruthenium, rhodium and iron.

10. The nanocomposite material according to claim 9, wherein each of the atomic clusters comprises iron atoms.

11. A heterogeneous or electrocatalyst comprising the nanocomposite material according to claim 1.

12. A method for preparing a nanocomposite material according to claim 1, said method comprising depositing a plurality of atomic clusters onto the surface of a solid substrate by physical vapor vapeur deposition (PVD), wherein each atomic cluster independently comprises from 1 to 20,000 atoms.

13. The method according to claim 12, wherein said method is a cluster beam deposition process, the method comprising the following steps:
(i) disposing within a matrix assembly cluster source (MACS) deposition chamber, a porous support substrate and a cluster target material comprising or consisting of atoms to be deposited as atomic clusters on/in said substrate;
(ii) forming a solid matrix comprising one or more source of Group 18 (noble gas) atoms in combination with atoms to be deposited as atomic clusters; and
(iii) performing a sputtering step in said deposition chamber, wherein said step comprises ion bombardment of the matrix formed in step (ii) to form a beam of atomic clusters which are directly deposited on to the surface and into the pores of said porous support substrate.

14. The method according to claim 12, wherein said method is an evaporation deposition process, the method comprising the following steps:
(i) disposing within a thermal evaporator, a porous support substrate and a cluster target material comprising or consisting of atoms to be deposited as atomic clusters on said substrate;
(ii) lowering the pressure within said evaporator to generate a vacuum; and
(iii) heating the cluster target material under vacuum, thereby generating evaporated cluster target particles, which are subsequently deposited on to the surface and into the pores of said porous support substrate by condensation.

15. The method according to claim 13, wherein the cluster target material comprises atoms of one or more metals, and wherein said metals are selected from: lead, silver, gold, platinum, molybdenum, tungsten, rhenium, cobalt, ruthenium, rhodium and/or iron.

16. The method according to claim 15, wherein the cluster target material comprises iron atoms.

17. A method for controlling the depth of deposition of atomic clusters within a porous support substrate, the method comprising the following steps:
(i) providing a porous support substrate in which the mean pore size of said substrate is between 0.8 d and 1.2 d, wherein d represents the maximum depth to which said atomic clusters are intended to be deposited; and
(ii) depositing a plurality of atomic clusters onto the surface and into the pores of said porous support substrate by PVD, wherein each of said atomic clusters comprises from 1 to 20,000 atoms.

18. A method for producing ammonia, the method comprising:
(i) disposing in a reactor a catalyst bed comprising a nanocomposite material according to claim 1;
(ii) passing one or more sources of nitrogen (N₂) and one or more sources of hydrogen (H₂) over said catalyst bed; and
(iii) obtaining a product stream comprising ammonia (NH₃).

19. The method according to claim 18, wherein step (ii) is carried out at a temperature in the range of from about 20° C. to about 250° C., and/or at a pressure of no more than about 3 MPa (30 bar).

20. The method according to claim 19, wherein step (ii) is carried out at a temperature in the range of from about 30° C. to about 75° C., and/or at a pressure of no more than about 1 MPa (10 bar).

21. The method according to claim 18, wherein the catalyst bed is reduced prior to step (ii), optionally by exposure to H₂ at a temperature up to about 400° C.

22. The method according to claim 18, wherein the one or more source of hydrogen is prepared from a green hydrogen feedstock, and/or the method is powered by renewable energy.
